(19) United States
(12) Patent Application Publication
(10) Pub. No.: US 2008/0038553 A1
(43) Pub. Date: Feb. 14, 2008

(54) Paper Coated with a Surface Layer Comprising Offset-Printable Silica

(75) Inventor: Laurence Avazzeri, Besse sur Braye (FR)

Correspondence Address: WESTERMAN, HATTORI, DANIELS & ADRIAN, LLP, 1250 CONNECTICUT AVENUE, NW, SUITE 700, WASHINGTON, DC, 20036, US

(73) Assignee: Arjo Wiggins Papiers Couches, Issy Les Moulineaux (FR)

(21) Appl. No.: 11/630,333

(22) PCT Filed: Jun. 24, 2005
(86) PCT No.: PCT/FR05/01594

§ 371 Date: Dec. 21, 2006

(30) Foreign Application Priority Data
Jun. 24, 2004 (FR) 0406923

(51) Int. Cl. B32B 5/16; B32B 17/00

(52) U.S. Cl. 428/402; 428/426

(57) ABSTRACT

The invention concerns a coated paper printable with offset printing using conventional offset inks drying in ambient air comprising, on at least one of its surfaces, a printable surface consisting of a pigmented composition consisting of at least one binder and pigments, including silica pigments in an amount ranging between 0.1 and 15% of the total dry weight of the composition. The invention also concerns the use of said coated paper in an offset printing process using conventional offset inks drying in ambient air, with a drying time of said inks less than 40 minutes after printing.

The present invention relates to a paper coated with a pigmented composition containing silica, intended for the offset printing process.

It is known in the prior art that the surface finish and visual appearance, but also printability, of a fibrous sheet based on natural and/or synthetic fibers is improved by coating the surface of said sheet with a composition consisting of one or more pigments and one or more binders. Many publications, such as for example “Paper Coating Pigments”, Tappi Monograph No. 38 (1976 edition), describe the advantages and disadvantages of various pigments used in the paper industry. The coating pigments most often used, by themselves or as a mixture, taking into account the qualitative, technical and economic requirements, are calcium carbonates, kaolins, talc, titanium dioxide and plastic pigments. But, the properties and characteristics required of a sheet of paper are partly dependent on the printing process for which the sheet is intended. The offset printing process for printing sheets with inks drying in the ambient air—one of the most widely used printing processes—has, among other requirements, that of requiring a drying time of the inks used that is sufficiently short to allow rapid use of the sheets once they have been printed.

The expression “conventional air-drying offset inks” is understood to mean offset inks that are conventionally used in the offset printing process that dry normally in air and at ambient temperature on the printed sheet by oxidation-polymerization and penetration of part of the ink vehicle. The drying of these inks does not require a particular supply of energy, such as infrared heating, or a UV or electron-beam treatment. In particular, said conventional normally air-drying offset inks are what are called “quadri” offset inks used on coated and uncoated papers intended for the packaging and publishing markets. As examples of conventional air-drying offset inks, reference may be made for example to the “quadri” offset inks of the TEMPO series sold by the company SICPA, those of the LOTUS serie or OPTIMA serie that are sold by the company LORILLEUX or those of the VERSO serie sold by the company BRANCHER. These conventional inks are sometimes also termed “fresh” or “semi-fresh” inks.

At the present time, in the field of matt coated paper, it is very difficult to obtain a good compromise between the mattness of the paper and the drying time of conventional air-drying offset printing inks, these two characteristics being mutually exclusive. This is because, to manufacture matt coated paper, it is general practice to use coarse pigments in order to achieve mattness, specially pigments of the calcium carbonate type of large particle size, but the use of such pigments results in a longer drying time of conventional offset printing inks.

Consequently, it is necessary to choose to favor one of these two characteristics to the detriment of the other, or to make a compromise with moderate values. The problem therefore becomes crucial when the aim is to develop ultra-matt coated paper.

In the gloss coated paper field, this phenomenon, of a very long drying time for conventional offset printing inks, may also be encountered.

In the case of high-gloss coated paper, the structure of the layer is extremely closed owing to the fact that the manufacturing process requires pronounced calendering or the paper is obtained by casting the layer on a chrome roll, called cast coating; the ink drying problem is exacerbated, the ink having difficulty in penetrating the paper and being difficult to dry.

The problem is also encountered in the case of paper coated with a layer containing special pigments giving a decorative effect, such as for example iridescent pigments or certain metallic or metallized pigments.

Currently, the drying times of conventional air-drying offset inks for coated papers may be very long, of the order of one hour or even up to several hours in the case of ultra-matt or high-gloss coated papers, or else in the case of special papers with for example iridescent pigments. For some high-gloss coated papers available on the market, a drying time of 6 hours has been observed.

Now, the drying time of offset inks after printing on a paper is a very important characteristic for the printer, as it is linked to the use of the printed paper. Consequently, conventional air-drying offset inks must meet the requirement of drying as rapidly as possible as soon as they have been deposited on their medium.

To remedy this problem of overly long drying time of conventional air-drying offset inks, the printer is sometimes forced to use special more quick-drying inks, which are normally used for offset printing on plastics and which inks, once deposited on the paper, will dry more rapidly.

However, these fast-drying inks have in particular the drawback of being expensive inks. They also have the drawback of drying extremely quickly in the inkers of printing machines.

Consequently, the ability of a paper to allow conventional air-drying offset inks to dry very rapidly, once they have been deposited on their medium, is a characteristic highly sought after by printers, in order to be able to handle the paper as rapidly and as easily as possible after printing, either to turn over the stacks of paper sheets printed on the front side so as to print them on the reverse side, or to carry out a conversion operation thereon (folding, cutting, embossing) without any risk of soiling, that is to say no undried ink being transferred onto the sheet on the top in a pile.

This problem becomes crucial when it is desired to develop coated papers ranging towards the extremes in terms of mattness or gloss and/or having special effects, such as coated papers with iridescent effects.

The object of the invention is consequently to provide coated papers that can be printed by offset printing having, after printing, a rapid drying time of conventional air-drying offset inks, more particularly for coated papers with extremes of mattness or gloss, or with special pigments.

One solution for remedying this problem would consist in increasing the absorption of the offset ink by the coating layer of the paper by the addition of additives into the layer. However, this runs the risk of causing the transvision defect (that is to say visibility on the reverse side of the sheet of the printing produced on the front side).

Among known coating pigments, silica is a pigment used for its optical properties, its matting power, brightness and opacity, and for its capability of partially replacing titanium dioxide.

Nevertheless, silica is a pigment little used in modern coating processes using compositions having a high solids content owing to its somewhat unfavorable rheological characteristics.

Silica is mainly used in papers intended for ink jet printing in which the requirements are specific and very different from those of the offset process.

Moreover, silica is known for its ability to immobilize the ink on the surface of a paper, thus reducing the transvision defect, but with the risk of increasing the ink drying time.

Surprisingly, the Applicant has found that it is possible to reduce the drying time of conventional air-drying offset inks printed on coated paper by incorporating a small amount of silica into the pigmented composition of the layer present on the surface of the paper, without appreciably disturbing the rheological properties of the pigmented composition employed, and in particular irrespective of whether the paper is a matt coated paper, a gloss coated paper or an iridescent coated paper.

Thus, the invention provides a coated paper that can be printed by offset printing with conventional air-drying offset inks, characterized in that it comprises, on at least one of its faces, a printable surface layer formed from a pigmented composition containing at least one binder and pigments, including silica pigments in an amount of between 0.1 and 15% of the total dry weight of pigments of said composition.

According to the invention, said coated paper is printable by offset printing with conventional air-drying offset inks with a drying time of less than 40 minutes, preferably of about 30 minutes or less.

Preferably, the silica content, by dry weight, is comprised between 0.5 and 15% of the total dry weight of pigments of the surface layer. More particularly, the silica content, by dry weight, is between 1 and 11% of the total dry weight of pigments of said surface layer.

According to the invention, the silica is preferably an amorphous synthetic silica.

The dry layer weight of the surface layer applied to at least one of the sides of the paper is between 2 and 30 g/m² per side. More particularly, the dry weight of the surface layer is between 2 and 20 g/m² per side.

The surface layer according to the invention contains at least one binder, which may be chosen from polyvinyl alcohol, styrene/butadiene copolymers (especially used in latex form) and blends thereof.

The pigments, other than silica, of the surface layer are chosen among calcium carbonates, kaolins, talc, titanium dioxide, plastic coating pigments, special pigments having an optical and/or decorative effect, and mixtures thereof.

According to one particular case of the invention, the plastic pigments of the surface layer are hollow microspheres of a styrene/acrylic copolymer having a mean size of between 1 and 0.1 μm.

According to the invention, the special pigments having an optical and/or decorative effect of the surface layer may be iridescent pigments.

According to one particular case of the invention, especially in the case of paper with a surface layer containing special pigments, in particular iridescent pigments, said surface layer includes a polyvinyl alcohol (PVA) as binder. More particularly, said layer has a PVA content of between 10% and 30% by dry weight, relative to the total dry weight of pigments of said layer. Preferably, said layer contains between 5 and 15% silica by dry weight, relative to the total dry weight of pigments of said surface layer. Also preferably, said pigmented composition of the surface layer contains at least 50% of plastic pigments by dry weight, relative to the total dry weight of pigments. In particular, said paper with iridescent pigments can be printed with a drying time of said offset inks of about 30 minutes or less.

According to one particular case, the invention relates to a matt paper; said paper, said surface layer of which contains between 1 and 5% silica by dry weight, relative to the total dry weight of pigments of the composition said layer has a degree of gloss, measured at 75° according to the international standard ISO 2813, of 20 or lower. Preferably, said paper is ultra-matt and its degree of gloss, measured at 75° according to the ISO 2813 standard, is equal to 15 or lower, preferably equal to 13 or lower. Preferably, said paper is printable with a drying time of conventional air-drying offset inks of 15 minutes or less.

According to another particular case, the invention relates to a gloss paper; said paper, the surface layer of which comprises between 1% and 10% silica by dry weight, relative to the total dry weight of pigments of said surface layer, has a degree of gloss, measured at 75° according to the ISO 2813 standard, of 70 or higher.

The invention makes it possible to provide papers having relatively high contents of plastic pigments used to give gloss; said surface layer may contain at least 5%, in particular at least 15%, of plastic pigments by dry weight, relative to the total dry weight of pigments. Preferably, said paper has a degree of gloss, measured at 75° according to the ISO 2813 standard, of 90 or higher.

Said invention makes it possible to provide ultra-glossy paper by incorporating into said surface layer unusually high levels of plastic pigment, said surface layer possibly containing between 15% and 60% of plastic pigments, preferably at least 30% and more preferably at least 50%, of plastic pigments by dry weight, relative to the total dry weight of pigments.

The glossy to ultra-glossy papers according to the invention are in particular printable with a drying time of said offset inks of about 20 minutes or less.

The invention also makes it possible to provide a paper that can be printed by offset printing on both its sides with a rapid drying time of conventional air-drying offset inks. Thus, the invention provides a paper that is characterized by it being coated on both its sides with said surface layer.

The offset-printable surface layer of the coated paper according to the invention may be deposited by any coating deposition means (coating or surface application or impregnation). Preferably, it is deposited by a knife coating process or by a contour coating process, such as air-knife coating or curtain coating.

The paper may have as base any fibrous sheet. In particular, the fibrous base is manufactured by a papermaking route using cellulose fibers and/or synthetic fibers.

The coated paper that can be printed by offset printing according to the invention may comprise, on at least one of its sides, in addition to the printable surface layer also comprising silica pigments in a small amount, at least one other layer of pigmented composition containing pigments and at least one binder. The other layer(s) of pigmented composition of said offset-printable coated paper is (are) defined as being sublayers, that is to say they are located beneath the offset-printable surface layer, and they may be deposited by any coating deposition means (coating or surface application or impregnation). According to the invention, one or more pigmented sublayers may be deposited in an amount of 2 to 20 g/m² by dry weight per side and per sublayer, depending on the coating deposition process used.

According to one particular case of the invention, said sublayer(s) of pigmented composition may be applied by means of a size press on the paper machine on which the paper base is produced. The size press may be of conventional type or it may be a modified model, for example a “speedsizer” as sold by Voith.

Other coating deposition processes may be used provided that they are appropriate for the application of the desired layer weights, it being possible for several sublayers to be applied using different processes. For example a first sublayer may be coated in a size press and a second pigmented sublayer may be applied by knife coating.

For example, in the case of surface treatment by a size press, that is to say coating on both sides, the dry weight of pigmented sublayer applied is between 4 and 20 g/m² per side.

According to the invention, the sublayer(s) of pigmented composition of the coated paper may contain, as pigments, fillers chosen from carbonates, kaolins, plastic coating pigments, titanium dioxide, special pigments having an optical and/or decorative effect, and mixtures thereof.

The binder used in the sublayer(s) of pigmented composition of the coated paper according to the invention may be a styrene/butadiene copolymer, in particular one that is carboxylated (used in latex form), and/or other conventional coating binders such as, for example, a starch and/or a polyvinyl alcohol. Preferably, a coated paper according to the invention has a grammage of between 80 and 500 g/m², more particularly between 90 and 400 g/m² (measured according to the ISO 536 standard).

The invention also relates to the use of a coated paper that can be printed by offset printing as defined above in an offset printing process with conventional air-drying offset inks. According to the invention, such a coated paper has the feature of being printable with conventional air-drying offset inks by offset printing with a drying time of said printed inks of less than 40 minutes, preferably about 30 minutes or less.

The invention also relates to the use of a pigmented composition containing at least one binder and pigments, including silica pigments in an amount of between 0.1 and 15% of the total dry weight of the pigments of said composition, in order to coat a sheet of paper on at least one of its sides and to make said sheet printable by offset printing with conventional air-drying inks in such a way that said inks dry in less than 40 minutes after printing. In particular, a pigmented composition as defined above is used. In particular, said pigmented composition is used to manufacture a coated paper as defined above.

The invention will be more clearly understood with the aid of the following nonlimiting examples:

### EXAMPLE 1

### Comparative Example

### Ultra-Matt Paper According to the Prior Art

### Containing No Silica

A Paper Having a Grammage of 90 g/m² was manufactured on a Fourdrinier paper machine and applied to the surface of this paper, by means of a size press, were 8 g/m² by total dry weight (4 g/m² per side) of a pigmented layer composed of calcium carbonate and starch.

Deposited off-line on each side of this 90 g/m² paper, by knife coating, was a pigmented composition in an amount of 15 g/m² by dry weight per side, said pigmented composition being produced in aqueous medium and comprising, in parts by dry weight per 100 parts by total dry weight of pigments:

| | |
|---|---|
| Calcium carbonate (mixture of carbonates | 100 parts |
| with 75% and 95% having a mean size <2 μm): | |
| Styrene/butadiene copolymer binder (used in | 10 parts |
| latex form): | |
| PVA: | 0.5 parts |
| Optical whitener: | 0.7 parts |

It had a gloss level of 12 measured according to the ISO 2813 standard by a Byk Gardner glossmeter oriented at 750 to the normal.

This paper was tested by offset printing on a Roland 4-color printing press. The drying time of the print was around 50 minutes.

### EXAMPLE 2

### Ultra-Matt Paper According to the Invention

A 90 g/m² paper was manufactured. As in Example 1, this paper was faced by a size press with 8 g/m² by total dry weight of a pigmented layer identical to that used in Example 1.

Deposited off-line on this 90 g/m² paper, by knife coating, on each side, was a pigmented composition in an amount of 15 g/m² by dry weight per side, said pigmented composition being produced in aqueous medium and comprising, in parts by dry weight per 100 parts total dry weight of pigments:

| | |
|---|---|
| Calcium carbonate (mixture of carbonates at | 97 parts |
| 75% and 95% having a mean size <2 μm): | |
| Amorphous synthetic silica (mean particle | 3 parts |
| size: 5-6 μm): | |
| Styrene/butadiene copolymer binder (used in | 10 parts |
| latex form): | |
| PVA: | 0.5 parts |
| Optical whitener: | 0.7 parts |

The paper had a gloss level of 11, measured at 75°.

The paper had a front side/reversed side Bekk smoothness of 134/99 seconds and an air permeability (Mariotte bottle device) measured according to French standard AFNOR NF-Q-03-075 of 54×10⁻³ cm³/(m²·Pa·s). As in Example 1, this paper was tested by offset printing on a Roland 4-color printing press. The drying time of the print was around 12 minutes. A substantial saving (38 minutes) in drying time over Example 1 for a similar mattness was therefore achieved.

### EXAMPLE 3

### Gloss Paper According to the Invention

A 150 g/m² coated paper (fibrous base coated with three successive pigmented layers) sold by the ArjoWiggins Group under the trademark CHROMOMAT® 150 g/m² was manufactured.

Deposited on this 150 g/m² coated paper, by curtain coating, was a layer of a pigmented composition, in an amount of 8 g/m² by dry weight per side, said pigmented composition being produced in aqueous medium and containing, in parts by dry weight per 100 parts total dry weight of pigments:

| | |
|---|---|
| Calcium carbonate: | 47 parts |
| Kaolin: | 47 parts |
| Amorphous synthetic silica: | 1 part |
| Plastic pigments (mixture of hollow | 5 parts |
| microspheres of a styrene/acrylic copolymer | |
| possessing a size of about 0.6 μm and | |
| 0.2 μm): | |
| Styrene/butadiene copolymer binder (used in | 10 parts |
| latex form): | |
| PVA: | 0.5 parts |
| Optical whitener: | 0.3 parts |

Thus, a coated paper formed from a fibrous base (based on cellulose fibers) coated with three pigmented sublayers and with a pigmented surface layer containing a small amount of silica was obtained.

The coated paper obtained was calendered. It had a gloss level of 85, measured at 75°.

The paper had a front side/reverse side Bekk smoothness of 4108/4086 seconds and an air permeability (Mariotte bottle device) measured according to French standard AFNOR NF-Q-03-075 of 10×10⁻³ cm³/(m²·Pa·s).

This paper was tested by offset printing on a Roland 4-color printing press. The drying time of the print was 20 minutes.

### EXAMPLE 4

### Ultra-Glossy Paper According to the Invention

A 170 g/m² coated paper (fibrous base coated with three successive pigmented layers) sold by ArjoWiggins Group under the trademark CHROMOMAT® 170 g/m² was manufactured.

Deposited on this 170 g/m² coated paper, by curtain coating, was a layer of a pigmented composition in an amount of 9 g/m² per side, said pigmented composition being produced in aqueous medium and comprising, in parts by dry weight per 100 parts by total dry weight of pigments:

| | |
|---|---|
| Calcium carbonate (carbonate with 80% of | 45 parts |
| pigments having a mean size <1 μm): | |
| Amorphous synthetic silica (mean size: | 5 parts |
| 5-6 μm): | |
| Plastic pigments (mixture of hollow | 50 parts |
| microspheres of a styrene/acrylic copolymer | |
| possessing a size of about 0.6 μm and | |
| 0.2 μm): | |
| Styrene/butadiene copolymer binder (used in | 10 parts |
| latex form): | |
| PVA: | 0.5 parts |
| Optical whitener: | 0.4 parts |

The paper obtained was calendered. It had a gloss level measured at 75° of 96.

This paper was tested by offset printing on a Roland 4-color printing press, the drying time of the print being 15 minutes.

### EXAMPLE 5

### Comparative Ultra-Glossy Paper (Containing no Silica)

A 170 g/m² CHROMOMAT® coated paper was manufactured as in Example 4.

Deposited on this 170 g/m² coated paper, by curtain coating, on each side, was a layer of a pigmented composition containing no silica, in an amount of 9 g/m² by dry weight per side.

This pigmented composition contained, in parts by dry weight per 100 parts by total dry weight of pigments:

| | |
|---|---|
| Calcium carbonate (carbonate with 80% of | 50 parts |
| pigments having a mean size <1 μm): | |
| Plastic pigments (mixture of hollow | 50 parts |
| microspheres of a styrene/acrylic | |
| copolymer possessing a size of about | |
| 0.6 μm and 0.2 μm): | |
| Styrene/butadiene copolymer binder (used | 10 parts |
| in latex form): | |
| PVA: | 0.5 parts |
| Optical whitener: | 0.4 parts |

The coated paper thus obtained was calendered. It had a gloss level, measured at 75° of 100.

This coated paper was tested by offset printing on a Roland 4-color printing press, the drying time of the print being 45 minutes.

In comparison, the ultra-glossy coated paper with silica according to the invention (Example 4) therefore allowed the drying time to be reduced by 30 minutes.

### EXAMPLE 6

### Iridescent Paper According to the Invention

Deposited on a 120 g/m² CHROMOMAT® coated paper (fibrous base coated with three successive pigmented layers), by curtain coating, on each side, was an iridescent pigmented composition in an amount of 3 g/m² by dry weight per side, said composition being produced in aqueous medium and containing, in parts by dry weight per 100 parts by dry total weight of pigments:

| | |
|---|---|
| Iridescent pigments of the titanium-coated | 35 parts |
| mica type: | |
| Amorphous synthetic silica (mean size: | 11 parts |
| 5-6 μm: | |
| Plastic pigments (mixture of hollow | 54 parts |
| microspheres of a styrene/acrylic | |
| copolymer possessing a size of about 0.6 μm | |
| and 0.2 μm): | |
| PVA: | 20 parts |

The paper obtained was calendered. It had a gloss level, measured at 75° of 55.

The paper had a front side/reverse side Bekk smoothness of 496/467 seconds and an air permeability (Mariotte bottle device) measured according to French standard AFNOR NF-Q-03-075 of 14×10⁻³ cm³/(m²·Pa·s).

This paper was tested by offset printing on a Roland 4-color printing press. The ink drying time was around 30 minutes.

### EXAMPLE 7

### Comparative Example of an Iridescent Paper

### Containing No Silica

Deposited on a 120 g/m² CHROMOMAT® paper, as in Example 6 by curtain coating, was a layer of an iridescent pigmented composition in an amount of 3 g/m² by dry weight per side, but this composition not containing any silica.

Said iridescent pigmented composition produced in aqueous medium comprised, in parts by dry weight per 100 parts by dry total dry weight of pigments:

| | |
|---|---|
| Iridescent pigments of the titanium-coated | 35 parts |
| mica type: | |
| Plastic pigments (mixture of hollow | 65 parts |
| microspheres of a styrene/acrylic | |
| copolymer possessing a size of about 0.6 μm | |
| and 0.2 μm): | |
| PVA: | 20 parts |

The coated paper thus obtained was calendered. It had a gloss level of 58, measured at 75°.

This paper was tested by offset printing on a Roland 4-color printing press. The ink drying time was several hours.

Tests and Results:

The conventional offset inks used for the tests on all the examples were semi-fresh air-drying offset inks of the OPTIMA serie from LORILLEUX.

To determine the ink drying time, the drying time after which there was no longer any transfer of ink onto one side of another identical paper was determined. To do this, the printed and tested side of the paper was superimposed on the virgin (unprinted) side of another identical paper (the virgin side being coated with the same pigmented composition) and then, using an Erichsen® press, a defined pressure (a force of 200 newtons) was applied by means of a calibrated piston (with a diameter of 4 cm) against the side opposite the tested side. The air drying time beyond which the ink mark caused by the piston was no longer transferred onto the virgin side was noted.

All these examples show that silica markedly improves the ink drying time. Moreover, the addition of silica makes it possible to incorporate higher levels of plastic pigments into the coating composition and thus obtain ultra-glossy paper that can be printed by offset printing with rapid drying times for conventional inks.

Furthermore, the rheology of the pigmented compositions with silica used in the examples was unaffected in comparison with the compositions containing no silica of the comparative examples, during their implementation in the coating process.

1. A coated paper printable by offset printing with conventional air-drying offset inks, which comprises, on at least one of its faces, a printable surface layer formed from a pigmented composition containing at least one binder and pigments, including silica pigments in an amount comprised between 0.1 and 15% of the total dry weight of pigments of said composition.

2. The coated paper as claimed in claim 1, which comprises, on at least one of its faces, at least one sublayer of pigmented composition containing pigments and at least one binder, which is placed beneath said surface layer.

3. The coated paper as claimed in claim 1, wherein the amount of silica, by dry weight, in said surface layer is comprised between 0.5 and 11% of the total dry weight of pigments of said pigmented composition.

4. The coated paper as claimed in claim 1, wherein said paper is printable with said offset inks with a drying time of less than 40 minutes.

5. The coated paper as claimed in claim 1, wherein the silica is an amorphous synthetic silica.

6. The coated paper as claimed in claim 1, wherein the pigments, other than silica, of said surface layer are chosen from calcium carbonates, kaolins, talc, titanium dioxide, plastic coating pigments, special pigments having an optical and/or decorative effect, and mixtures thereof.

7. The coated paper as claimed in claim 1, wherein the binder of said surface layer is chosen from polyvinyl alcohols, styrene/butadiene copolymers, and blends thereof.

8. The coated paper as claimed in claim 1, wherein the dry weight of said surface layer is between 2 and 20 g/m² per side.

9. The coated paper as claimed in claim 6, wherein said plastic pigments are hollow microspheres of a styrene/acrylic copolymer having a mean size of between 1 and 0.1 μm.

10. The coated paper as claimed in claim 6, wherein said special pigments having an optical and/or decorative effect are iridescent pigments.

11. The coated paper as claimed in claim 10, wherein the binder of said surface layer is a polyvinyl alcohol, preferably with a content of between 10% and 30% by dry weight, relative to the total dry weight of pigments of said composition.

12. The coated paper as claimed in claim 10, wherein said surface layer contains between 5 and 15% silica by dry weight, relative to the total dry weight of pigments of said pigmented composition.

13. The coated paper as claimed in claim 10, wherein said pigmented composition of the surface layer contains at least 50% of plastic pigments by dry weight, relative to the total dry weight of pigments.

14. The coated paper as claimed in claim 10, which can be printed with a drying time of said offset inks of 30 minutes or less.

15. The coated paper as claimed in claim 1, wherein said surface layer comprises between 1 and 5% of silica by dry weight, relative to the total dry weight of pigments of the composition, and said coated paper has a degree of gloss, measured at 75° according to the international standard ISO 2813, of 20 or lower.

16. The coated paper as claimed in claim 15, which has a degree of gloss, measured at 75° according to the ISO 2813 standard, of 15 or less, preferably equal to 13 or lower.

17. The coated paper as claimed in claim 15, which is printable with a drying time of said offset inks of 15 minutes or less.

18. The coated paper as claimed in claim 1, wherein said surface layer comprises between 1% and 10% silica by dry weight, relative to the total dry weight of pigments of the composition, and wherein said coated paper has a degree of gloss, measured at 75° according to the ISO 2813 standard, of 70 or higher.

19. The coated paper as claimed in claim 18, wherein said surface layer contains at least 5% of plastic pigments by dry weight, relative to the total dry weight of pigments.

20. The coated paper as claimed in claim 19, which has a degree of gloss, measured at 75° according to the ISO 2813 standard, of 90 or higher.

21. The coated paper as claimed in claim 20, wherein said pigmented composition contains at least 30%, preferably at least 50%, of plastic pigments by dry weight, relative to the total dry weight of pigments.

22. The coated paper as claimed in claim 18, which is printable with a drying time of said offset inks of 20 minutes or less.

23. The coated paper as claimed in claim 1, which is coated on both its sides with said surface layer.

24. The coated paper as claimed in claim 2, wherein said sublayer contains pigments chosen from calcium carbonates, kaolins, talc, titanium dioxide, plastic coating pigments, special pigments having an optical and/or decorative effect, and mixtures thereof.

25. The coated paper as claimed in claim 2, wherein said sublayer contains a binder chosen from polyvinyl alcohols, starches, styrene/butadiene copolymers, and blends thereof.

26. An offset printing process comprising applying conventional air-drying offset inks on a coated paper as defined in claim 1, said printed inks drying in less than 40 minutes, preferably in a time of 30 minutes or less.

27. The process as claimed in claim 26, wherein said printed offset inks dry in a time of 30 minutes or less.

28. The A method of coating a sheet of paper for offset printing, comprising coating a sheet of paper on at least one of its sides with a pigmented composition containing at least one binder and pigments, of which silica pigments in an amount of between 0.1 and 15% of the total dry weight of pigments of said composition, in order to make said sheet printable by offset printing with conventional air-drying offset inks in such a way that said inks dry in less than 40 minutes after printing.

29. The method as claimed in claim 28, wherein the pigmented composition is a composition containing at least one binder and pigments, including silica pigments in an amount comprised between 0.1 and 15% of the total dry weight of pigments of said composition, wherein the amount of silica, by dry weight, in said surface layer is comprised between 0.5 and 11% of the total dry weight of pigments of said pigmented composition.

30. The method as claimed in claim 28, wherein said sheet of paper contains one or more pigmented sublayers on which said pigmented composition containing the silica pigments is deposited, wherein said sublayer contains pigments chosen from calcium carbonates, kaolins, talc, titanium dioxide, plastic coating pigments, special pigments having an optical and/or decorative effect, and mixtures thereof.

31. The method as claimed in claim 28, wherein the coated paper comprises on at least one of its faces, a printable surface layer formed from a pigmented composition containing at least one binder and pigments, including silica pigments in an amount comprised between 0.1 and 15% of the total dry weight of pigments of said composition, wherein at least one sublayer of pigmented composition containing pigments and at least one binder is placed beneath said surface layer.
